(19) United States
(12) Patent Application Publication
(10) Pub. No.: US 2012/0200399 A1
(43) Pub. Date: Aug. 9, 2012

(54) TRANSMISSION APPARATUS FOR REMOTELY INDICATING POSITION AND RECEPTION APPARATUS

(76) Inventor: Kwang Muk Chae, Seongnam-si Gyeonggi-do (KR)

(21) Appl. No.: 13/393,726

(22) PCT Filed: Sep. 2, 2010
(86) PCT No.: PCT/KR2010/005940

§ 371 Date: Apr. 17, 2012

(30) Foreign Application Priority Data
Sep. 2, 2009 (KR) 10-2009-0082604

(51) Int. Cl. G08C 19/16

(52) U.S. Cl. 340/12.22

(57) ABSTRACT

A transmitting apparatus and receiving apparatus for indicating a position can be remotely controlled. The transmitting apparatus includes a means for measuring an inclined angle of a transmitter with respect to a gravity axis of the earth to measure and transmit the inclined value of the transmitter in addition to transmitting waveforms having different phase angles and the same frequency simultaneously and the receiving apparatus is configured by a receiving apparatus that receives and ultimately amplifies the transmitted signal and processes the amplified signal so as to acquire positional information regarding a shift of a phase which is shifted from a reference signal.

### CROSS-REFERENCE TO RELATED APPLICATION

This application claims priority from and the benefit under 35 U.S.C. §119(a) of Korean Patent Application No. 10-2009-0082604, filed on Sep. 2, 2009, which is hereby incorporated by reference for all purposes as if fully set forth herein.

### BACKGROUND OF THE INVENTION

1. Field of the Invention

The present invention relates to a transmitting apparatus and a receiving apparatus for remotely indicating a position, and more particularly, to a remotely controlled position indicating system constituted by a transmitting apparatus that includes a means for measuring an angle inclined with respect to a gravity axis and a touch switch to transmit waveforms of the same frequency having different phase angles, respectively and a receiving apparatus for receiving and processing a signal transmitted from the transmitting apparatus.

2. Description of the Prior Art

In general, in addition to a remotely controlled transmitting apparatus such as a remote controller, a transmitting apparatus for remotely indicating a position using an orientation direction of the transmitting apparatus as remote position information in a body monitor such as a TV has been developed.

The transmitting apparatus for remotely indicating a position generally transmits a signal to various electronic apparatuses having a remote position indicating system which is separated by a predetermined distance through two or more transmitters simultaneously. As a result, the conventional remote position indicating system uses a method of amplifying respective received signals in a circuitry or optical method and analog/digital-converting the amplified signals to convert a difference between magnitudes of the respective signals into a coordinate system or a method of staggering outputting a signal and processing the outputted signal in a receiver when it is difficult to discriminate the signals received simultaneously. Therefore, since an apparatus that requires a very complicated circuit and high-level optical precision is requisite in order to process the received signal in the remote position indicating system in the related art, a manufacturing cost is high. Further, since a direct current (DC) signal which is easily processed is used for measurement in order to satisfy measurement precision, discrimination for noise depending on a surrounding situation is insufficient, such that it is difficult to increase precision at the time of indicating the position, and as a result, resolution capable of indicating the position deteriorates or a distance remarkably decreases, that is, practicality is made difficult.

In addition, since a signal processing method in the remote position indicating system in the related art is significantly different from the transmitting apparatus for remotely indicating a position in the related art, it is difficult to integrate with the transmitting apparatus for remotely indicating a position and since core signal processing related with precision depends on an analog circuit, it is difficult to miniaturize the circuit through customization and it is hard to achieve a cost saving effect by complex integration.

Besides, in some related arts proposed in order to solve the above problems, even though effects are achieved to some degree in terms of miniaturization and cost saving, core information such as an inclination degree of the transmitter is not transferred, such that in a situation in which the position is not remotely indicated as a user intends, for example, when the user operates the transmitting apparatus while the user lies down, a vertical indicating direction of the signal transferred from the transmitting apparatus is an ultimately horizontal indicating direction in the receiving apparatus. Therefore, the transmitting apparatus for remotely indicating a position could not be practicalized.

### SUMMARY OF THE INVENTION

Accordingly, the present invention has been made to solve the above-mentioned problems occurring in the prior art, and an object of the present invention is to provide a transmitting apparatus and a receiving apparatus for remotely indicating a position, which facilitate position indication for selection of a menu and indication and input of a function by digitally processing a signal specifically signalized and transmitted from the transmitting apparatus in the receiving apparatus to decrypt an orientation direction of the transmitting apparatus.

In order to accomplish this object, in accordance with an aspect of the present invention, there is provided a transmitting apparatus for remotely indicating a position of a plane provided in a receiving apparatus, including: a button switch input unit including a button switch; a slope sensor measuring a slope of the transmitting apparatus with respect to a gravity axis; and two or more transmitters transmitting waveforms for transmitting positional information signals having different phases and the same frequency to the receiving apparatus so as to acquire positional information from the shift of the phase which is received by the receiving apparatus and shifted from a reference signal, wherein slope value information measured by the slope sensor is included in the waveform.

The apparatus may further include a touch-type touch switch for displaying a start and an end of transmission of the waveforms for transmitting positional information signals.

In accordance with another aspect of the present invention, there is provided a position indication transmitting apparatus mounted on a general transmitting apparatus to remotely indicate a position on plane provided in a receiving apparatus, including: a slope sensor measuring a slope of the transmitting apparatus with respect to a gravity axis; two or more (preferably, four) transmitters transmitting waveforms for transmitting positional information signals having different phases and the same frequency to the receiving apparatus so as to acquire positional information from the shift of the phase which is received by the receiving apparatus and shifted from a reference signal; and a control unit receiving an output signal of the existing transmitting apparatus and transmitting the output signal including the slope value from the slope sensor and the positional information.

The receiving apparatus may further include a low-frequency oscillator (LFO) outputting a low-frequency waveform of a cycle corresponding to the number of measurements N for accumulation with respect to the cycle of the received waveform so as to minutely swing a phase of the received waveform in order to improve resolution of a received coordinate in an accumulation method by multiple samplings.

According to the present invention, an input corresponding to user's motion such as movement of a cursor or changes of a visual field, an indicating direction, and the like can be facilitated in using electronic apparatuses, e.g., a TV, a computer, a VCR, an LDP, a DVD player, various VOD systems, IP TV and cable TV terminals, various communication terminals, a home game machine, a computer for children, a head mounted display (HMD) device, and the like.

In particular, even when an operating surface of a transmitting apparatus is inclined, a position can be accurately designated by appropriate correction and measurement of an accumulation method is enabled by mixing a predetermined frequency with a received signal to improve resolution.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram showing an orientation characteristic curve of a general transmitter;

FIGS. 2 to 5 are waveform diagrams showing a waveform generation principle of a position indicating system which can be remotely controlled;

FIGS. 6 to 8 are diagrams showing a coordinate determining process of the position indicating system which can be remotely controlled according to the present invention, in which FIG. 6 is a diagram showing a process of determining a coordinate at a left side of the center of a screen, FIG. 7 is a diagram showing a process of determining a coordinate at a right side of the center of the screen, and FIG. 8 is a diagram showing a process of determining a final coordinate by correcting a slope of a transmitter;

FIG. 9 is a block diagram of a transmitting apparatus for remotely indicating a position according to an exemplary embodiment of the present invention;

FIGS. 10 and 11 are flowcharts describing an operation in the transmitting apparatus for remotely indicating a position according to the exemplary embodiment of the present invention;

FIG. 12 is a control timing diagram of the transmitting apparatus according to FIG. 9;

FIGS. 13 and 14 are perspective views showing a placement structure of the transmitter in FIG. 9;

FIG. 15 is a waveform diagram showing a sine wave substitution principle used in the exemplary embodiment of the present invention;

FIG. 16 is a block diagram showing a configuration of a reception amplifying unit of a receiving apparatus for remotely indicating a position according to an exemplary embodiment of the present invention;

FIG. 17 is a principle diagram of a method of improving position indication resolution of an accumulation method using LFO synthesis according to an exemplary embodiment of the present invention;

FIG. 18 is a block diagram showing a digital signal processing circuit of the transmitting apparatus for remotely indicating a position according to the exemplary embodiment of the present invention;

FIG. 19 is a timing diagram showing a digital signal processing process in FIG. 18;

FIG. 20 is a flowchart of a digital filter and a demodulation state in the receiving apparatus according to FIG. 18;

FIG. 21 is a flowchart of signal processing in the receiving apparatus according to FIG. 18;

FIG. 22 is a flowchart showing an operation in a control unit after reception interruption occurs in the flowchart of FIG. 21;

FIG. 23 is a block diagram illustrating a method for maintaining compatibility by adding the transmitting apparatus of the present invention to an existing general transmitting apparatus; and

FIG. 24 is a timing diagram showing a sequence change and a processing method of signal processing of the transmitting and receiving apparatuses according to FIG. 23.

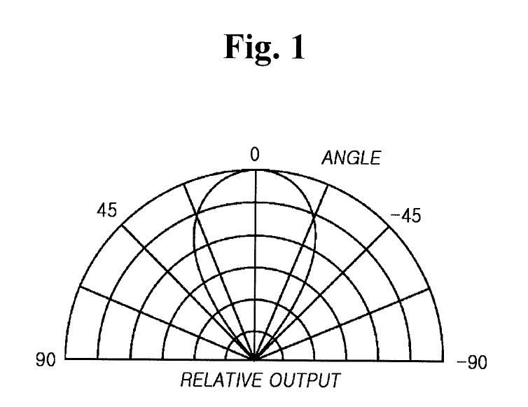

### DESCRIPTION OF REFERENCE NUMERALS OF PRINCIPAL ELEMENTS IN THE DRAWINGS

10: touch switch
20: control unit
40: square wave generating unit
200: reception amplifying unit
310: clock oscillating unit
312: phase locked loop (PLL) circuit
320: serial-parallel conversion circuit
322: divider circuit
324: slope value extracting unit
326: R-S flip-flop
328: phase comparing range generator
330: phase difference counting circuit
332: phase value calculating unit
334: position value storing register
336: serial/parallel interface
338: system resetting circuit
400: control unit

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

Hereinafter, a basic principle of a technology adopting the present invention will be described in detail with reference to the accompanying drawings.

Basically, since a sine waveform and a cosine waveform which are sine waves are basic mathematical units, the simplest calculation can be performed and the sine waveform and the cosine waveform have a phase difference of 90° from each other. Therefore, the sine waveform and the cosine waveform satisfy a condition as one kind of simplest waveform among various kinds of waveforms which can be used for a transmitter in an exemplary embodiment of the present invention.

A relationship with a phase shift phenomenon for a bandwidth generated when two waveforms are synthesized with each other will be described below by applying two waveforms, in which a new coordinate (x′,y′) when a point (x,y) rotates only by θ can be generally defined by Equation 1 below.

x′=x cos θ−y sin θ

y′=x sin θ+y cos θ [Equation 1]

When a state in which basic phases of sin θ and cos θ are shifted by α is induced to an equation by substituting figures into the above equation, the induced equation becomes Equations 2 and 3 below.

cos(θ+α)=cos θ cos α−sin θ sin α [Equation 2]

sin(θ+α)=sin θ cos α+cos θ sin α [Equation 3]

Meanwhile, in the exemplary embodiment of the present invention, when a transmitting apparatus transmits a frequency signal for detecting left and right positions, two transmitters are used with respect to each one axis between horizontal and vertical axes on a plane. On the assumption that a method of transmitting frequency signals having different phases simultaneously from the transmitters is adopted, a signal inputted into a receiving apparatus having a signal processing unit is necessarily the sum of two signals, and as a result, Equation 3 is appropriate and if waveforms from two transmitters are sin θ and cos θ having the same frequency, a result which completely coincides with Equation 3 can be acquired.

In more detail, when sin θ and cos θ are simultaneously transmitted from two transmitters, respectively and received by the receiver, a difference in bandwidth received depending on a reception position of the receiver occurs with respect to a transmission angle of the transmitter due to an orientation characteristic of the transmitter and a magnitude (bandwidth) of an input waveform inputted into the receiver is assumed as kA with respect to a sine side and kB with respect to a cosine side and when cos α is assumed as A and sin α is assumed as B, a received synthetic wave is k sin α. A relationship thereof is shown in Equation 4 below.

kA sin θ+kB cos θ=k sin(θ+α)(wherein, it is assumed that A=cos α and B=sin α) [Equation 4]

That is, each term is multiplied by a constant k that satisfies a predetermined bandwidth value.

Therefore, Equation 5 below is satisfied.

$$\frac{B}{A} = \frac{sin α}{cos α} = tan α \qquad [ Equation 5 ]$$

Consequently, according to Equation 5, a phase shift of a shown in Equation 6 below is achieved with respect to a bandwidth of a waveform received from a transmitter generating a sine wave and a bandwidth of a waveform received from a transmitter generating a cosine wave through a theory adopted in the present invention. That is, the phase shift α is shown in Equation 6 below.

$$α = {tan}^{- 1} \frac{B}{A} \qquad [ Equation 6 ]$$

Therefore, a ratio of the bandwidth B from the sin-side transmitter and the bandwidth A from the cos-side transmitter may be calculated by measuring the phase shift α of the synthetic wave and an orientation angle of the transmitter to the receiver may be accurately converted by referring to a physical property for the transmitter to which the calculated result is applied, i.e., a transmitter orientation property curve.

However, in general, in the case where a transmission angle of the transmitting apparatus and a reception position which the receiving apparatus should indicate do not need to accurately coincide with each other during use of the transmitting apparatus such as a remote controller, i.e., when the reception position does not need to be a reception trajectory linearly coinciding with the transmission angle like a target impact of a direct fire weapon, it is possible, without causing a big problem, to directly convert the shift α simply into an axial movement distance of a plane, in consideration of a proportional equation of the term.

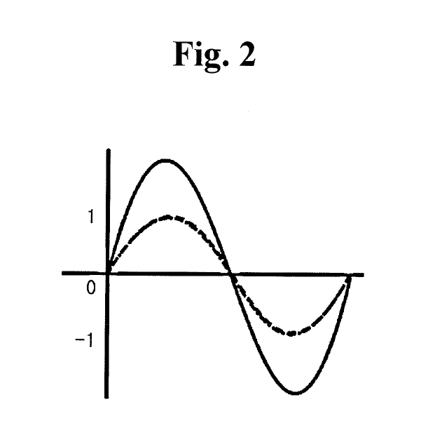

In order to verify the above principle, FIGS. 2 to 5 will be referred.

FIGS. 2 to 5 show a synthesis example of waveforms using a sine waveform and a cosine waveform as a waveform generation principle according to the present invention.

As shown in FIGS. 2 to 5, at the time of transmitting the sine waveform used as a reference signal and the synthetic wave of the sine waveform and the cosine waveform used as position designating signals, magnitudes (bandwidths) of waveforms received by the receiving apparatus are classified into three cases of sin=cos, sin<cos, and sin>cos according to the orientation direction of the transmitting apparatus and a synthetic waveform thereof is acquired.

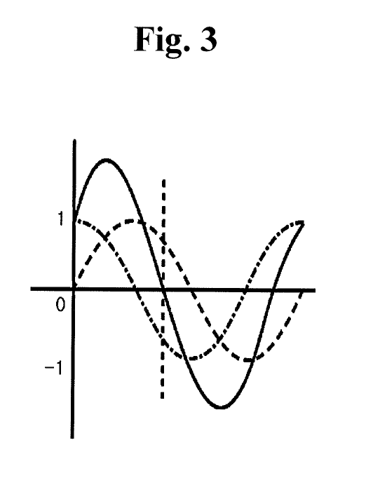

FIG. 2 shows a case where both transmitters output the sine waveform as the reference signal and even though both transmitters have any bandwidth rate, a phase shift is not naturally generated. FIG. 3 shows the case in which the magnitude (bandwidth) of the received waveform is sin=cos and as shown in the equation, an intermediate value of the sine waveform and the cosine waveform becomes a phase shift value (the phase shift) as tan⁻¹=45.

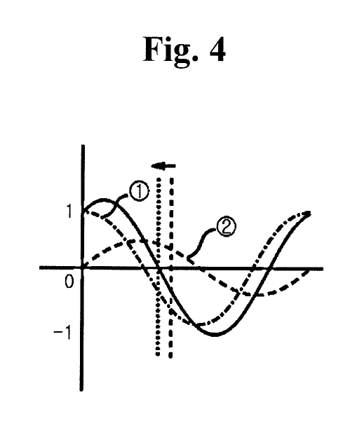

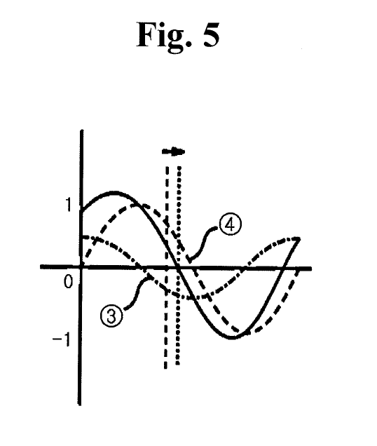

Further, FIG. 4 shows the case in which the magnitude (bandwidth) of the received waveform is sin<cos and as shown in the figure, a phase of the synthetic waveform is ultimately tan⁻¹∞=90 to approach cos=0° and FIG. 5 shows the case in which the magnitude (bandwidth) of the received waveform is sin>cos and the phase of the synthetic waveform is ultimately tan⁻¹0=0 to approach a phase of sin=0°. Therefore, it can be seen that the result such as shown in the equation is acquired.

In the exemplary embodiment of the present invention, an infrared light emitting diode and a photodiode in which a circuit is comparatively simply configured are used as the transmitter and the receiver, respectively, but the present invention is not limited to this.

In general, a significantly complicated circuit is required to acquire sine waves of the sine waveform and the cosine waveform through a physical circuit.

Accordingly, in the case where a square wave generally passes through a band filter of a corresponding frequency, only a sine (sin) wave component as a basic wave is left, and as a result, a square wave having sine and cosine phases is generated from a first transmitter in the exemplary embodiment of the present invention. In the receiver, the square wave signal is received and thereafter, filtered by using a band pass filter corresponding to the frequency of the square wave during amplification, such that the same effect as receiving the sine wave of the cosine waveform may be acquired. In this case, a phase shift amount accurately coincides with the above equation.

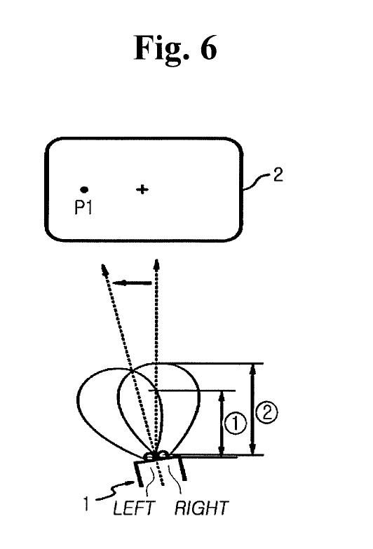

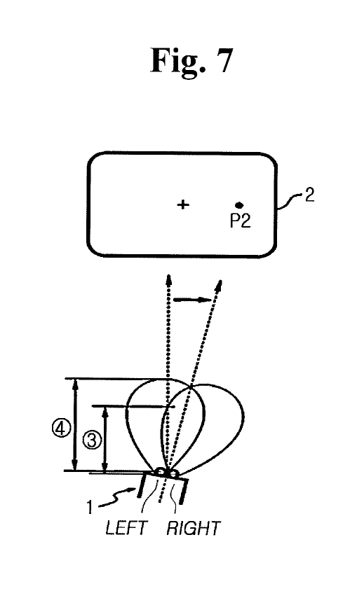

FIGS. 6 to 8 schematically show a coordinate determining process of a position indicating system which can be remotely controlled according to an exemplary embodiment of the present invention. FIG. 6 is a diagram showing a process of determining a coordinate at a left side of the center of a screen and FIG. 7 is a diagram showing a process of determining a coordinate at a right side of the center of the screen. As shown in the figure, in the case where a predetermined frequency signal is transmitted onto a screen 2 while a transmitting apparatus 1 moves from the center of the screen 2 to the left side by a predetermined angle, a left signal sin and a right signal cos have predetermined orientation characteristic curves, respectively, and as a result, through waveform analysis, in this state, since the left signal sin<the right signal cos, the phase of the synthetic wave shifts from the center to the left side of a basic synthetic wave, as shown in FIG. 4. Therefore, a coordinate P1 is determined at a position slightly to the left of the center of the screen.

Further, in the case where the frequency signal is transmitted onto the screen 2 while the transmitting apparatus 1 moves from the center of the screen 2 to the right side by a predetermined angle, the left signal sin and the right signal cos have predetermined orientation characteristic curves, respectively, and as a result, through waveform analysis, in this state, since the left signal sin>the right signal cos, the phase of the synthetic wave shifts from the center to the right side of the basic synthetic wave, as shown in FIG. 5. Therefore, a coordinate P2 is determined at a position slightly to the right of the center of the screen.

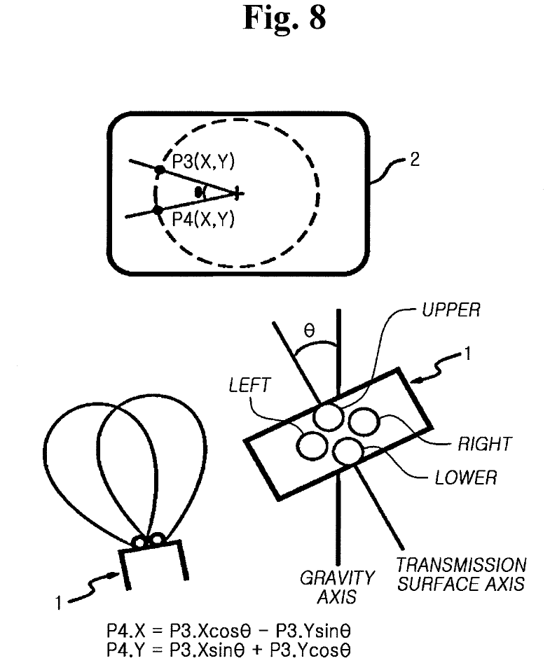

The process is considered only in regard to the left and right sides, but when the coordinate is determined by measuring upper and lower sides in the same method, P3 is determined in FIG. 8.

Waveforms \textcircled{1}, \textcircled{2}, \textcircled{3}, and \textcircled{4} having predetermined phases in FIGS. 4 and 5 represent \textcircled{1}, \textcircled{2}, \textcircled{3}, and \textcircled{4} in the orientation characteristic curve from the transmitter in FIGS. 6 and 7.

However, in the above case, P3 is achieved when a vertical axis of the transmitting apparatus and a vertical axis of the receiving apparatus accurately coincide with each other and in general, the receiving apparatus is installed so that a gravity axis of the earth and the vertical axis coincide with each other. However, it cannot be considered that the vertical axis of the transmitting apparatus at a moment of transmission coincides with the vertical axis (gravity axis of the earth) of the receiving apparatus due to portability, so that a problem in determining a relative position occurs.

In other words, for example, since a TV or a set-top box which is the receiving apparatus is installed on a horizontal surface, the vertical axis of the receiving apparatus is inclined toward the gravity axis (in a vertical direction) of the earth, while a user may operate the remote controller which is the transmitting apparatus at any angle, such that when the user ultimately operates the remote controller while the user lies down, the vertical axis of the transmitting apparatus is substantially vertical to the gravity axis of the earth. In other words, since a reference coordinate system (transmission coordinate system) of the transmitting apparatus and a reference coordinate system (reception coordinate system) of the receiving apparatus do not correspond to each other, the position cannot be indicated as the user intends.

Accordingly, as one feature of the present invention discriminated from the related method, in the exemplary embodiment of the present invention, a slope of the transmitting apparatus is measured at the moment of transmission to transmit information on the slope value to the receiving apparatus and when the slope value (angle) θ is extracted in the receiving apparatus to acquire a final coordinate P4 by rotating P3 acquired through the process by the angle θ on the basis of the center of the reception coordinate system 2 by a rotating equation, a coordinate which the user intends to indicate can be finally acquired. In the specification, this is defined as coordinate correction depending on the slope of the transmitting apparatus.

In other words, as shown in FIGS. 6 to 8, an acquired position is P3=(P3.X, P3.Y) without considering the slope and when the slope value between the transmitting apparatus and the gravity axis (the vertical axis of the receiving apparatus) is θ, P4=(P4.X, P4.Y) which is a coordinate-corrected position depending on the slope is shown in Equation 7.

P4.X=P3.X cos θ−P3.Y sin θ

P4.Y=P3.X sin θ+P3.Y cos θ [Equation 7]

FIG. 8 shows a method for coordinate correction depending on the slope of the transmitting apparatus. Measurement of the slope of the transmitting apparatus and a transmission method of the slope value will be described below in more detail.

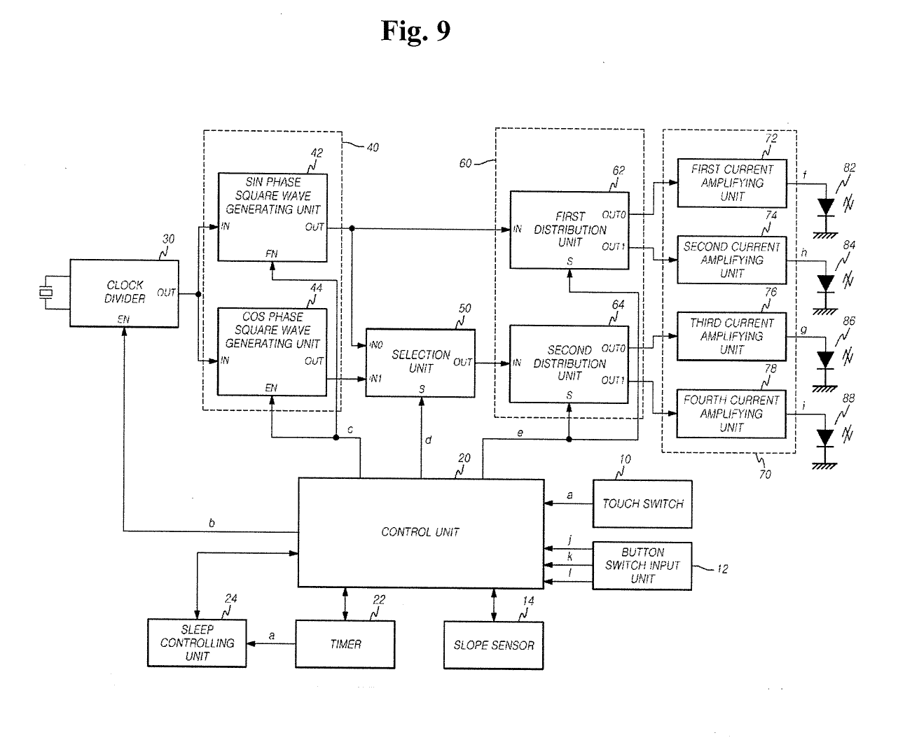

FIG. 9 is a block diagram showing the transmitting apparatus 1 in the position indicating system which can be remotely controlled according to the exemplary embodiment of the present invention.

The remote indication transmitting apparatus according to the exemplary embodiment of the present invention includes a button switch input unit including a button switch 12, a slope sensor 14 measuring the slope of the transmitting apparatus in relation to the gravity axis, and two or more transmitters 82, 84, 86, and 88 transmitting a waveform for transmitting a positional information signal of the same frequency having different phases so as to acquire positional information from a shift of a phase received by the receiving apparatus and shifted with respect to the reference signal. The slope value information measured by the slope sensor is included in the waveform.

Further, the remote indication transmitting apparatus may further include a touch type touch switch for displaying a transmission start or end of the waveform for transmitting the positional information signal.

As a more detailed configuration, the transmitting apparatus 1 includes a control unit 20 generating a control signal according to an operation of the touch switch, a clock divider 30 generating a clock of a predetermined frequency according to the control signal of the control unit, a square wave generating unit 40 generating a square wave of sine and cosine waveforms according to the clock generated by the clock divider, a selection unit 50 receiving the square wave of the sine and cosine waveforms of the square wave generating unit and outputting a selection signal by the control signal of the control unit, and a distribution unit 60 receiving one square wave of the square wave generating unit and applying a predetermined output signal according to the control signal of the control unit, and a current amplifying unit 70 amplifying a distribution signal applied by the distribution unit. A detailed configuration will be additionally described below.

In general, in the case where a push-type button or switch is used in the transmitting apparatus adopting the exemplary embodiment of the present invention, a vertical axis orientation direction of the transmitting apparatus is substantially influenced by a change of pressure of a finger when the user presses or releases the button attached to the transmitting apparatus.

Accordingly, in another exemplary embodiment of the present invention, the transmitting apparatus includes an additional touch switch that operates regardless of pressure in order to display a start and an end of transmission of the positional information signal in addition to a general push button type switch input unit.

Therefore, as shown in FIG. 9, reference numeral 10 represents a touch switch for displaying the start and the end of transmission of the positional information and reference numeral 12 represents a button switch input unit for a general function. The touch switch and the button switch input unit output a predetermined number (three in the exemplary embodiment) of control signals to the control unit 20.

By the exemplary embodiment of the present invention, a cursor is fixed to an indication position at the time of releasing a touch of the touch switch while indicating and moving a predetermined position on the screen of the receiving apparatus while a user touches the touch switch of the transmitting apparatus and a corresponding button switch input signal is received to perform corresponding control.

Of course, since the touch switch may be used in another method, when the touch switch is touched once, the position indication starts. Thereafter, a predetermined position of the screen of the receiving apparatus is indicated while moving and thereafter, when the touch switch is touched again in the case where the control signal is determined to be transmitted, the receiving apparatus determines a cursor position at that time as a control position which the user desires and thereafter, the button switch input signal is received to perform the corresponding control. After a desired control is performed, the touch switch is touched again. Thereafter, a cursor can be moved so as to determine the position again.

As such, only while the touch switch is touched, the position is indicated and the touch switch is used to specify a start time and an end time of transmission of the positional information in a method of determining a position at the time of releasing the touch as a control target position or a method in which the position is indicated during a period between the time when the touch switch is touched once and a subsequent touch.

The control unit 20 measures a slope which is an angle between the gravity axis of the earth and the vertical axis of the transmitting apparatus by using the slope sensor 14 provided in the transmitting apparatus when the signal from the touch switch 10 is applied. The slope sensor measures the acceleration of gravity by using an acceleration sensor of two axes or more as a slope of a button operating surface of the transmitting apparatus to calculate the slope. Further, in the case where various and dedicate angle detections are not required, a mercury switch may be used.

However, the slope sensor for measuring the slope is not limited to the above-mentioned configuration and any configuration which can measure the slope of the button operating surface of the transmitting apparatus with respect to the gravity axis may be adopted.

Further, the control unit 20 outputs predetermined control signals to the clock divider 30, the square wave generating unit 40, a selection unit 50, and the distribution unit 60. Reference numeral 22 represents a timer generating a predetermined timing clock and reference numeral 24 represents a sleep controlling unit for minimizing power consumption of the transmitting apparatus.

An enable (EN) terminal of the clock divider 30 is activated by the control signal of the control unit 20, such that the clock divider 30 outputs a predetermined clock signal.

An enable (EN) terminal of the square wave generating unit 40 is activated by the control signal of the control unit 20 and the square wave generating unit 40 includes sine and cosine phase square wave generating units 42 and 44 generating the square waves having the sine and cosine phases, respectively in synchronization with the clock inputted from the clock divider 30.

The control signal of the control unit 20 is inputted through a selection terminal S, such that the selection unit 50 selects and outputs one of output signals of sine and cosine phase generating units 42 and 44 of the square generating unit 40 inputted into input terminals IN0 and IN1, respectively.

An imputer terminal IN of the distribution unit 60 is connected to an output terminal OUT of the sine phase generating unit 42 and an output terminal OUT of the selection unit 50 and the distribution unit 60 includes first and second distribution portions 62 and 64 each having the selection terminal S.

Reference numeral 70 as a current amplifying unit includes first and second current amplifying units 72 and 74 connected with two output terminals OUT0 and OUT1 of the first distribution portion 62, respectively and third and fourth current amplifying portions 76 and 78 connected with two output terminals OUT0 and OUT1 of the second distribution portion 64, respectively. The first to fourth current amplifying units 72 to 78 transmits predetermined infrared signals and are connected with infrared transmitters 82, 84, 86, and 88 in which one side is grounded, respectively.

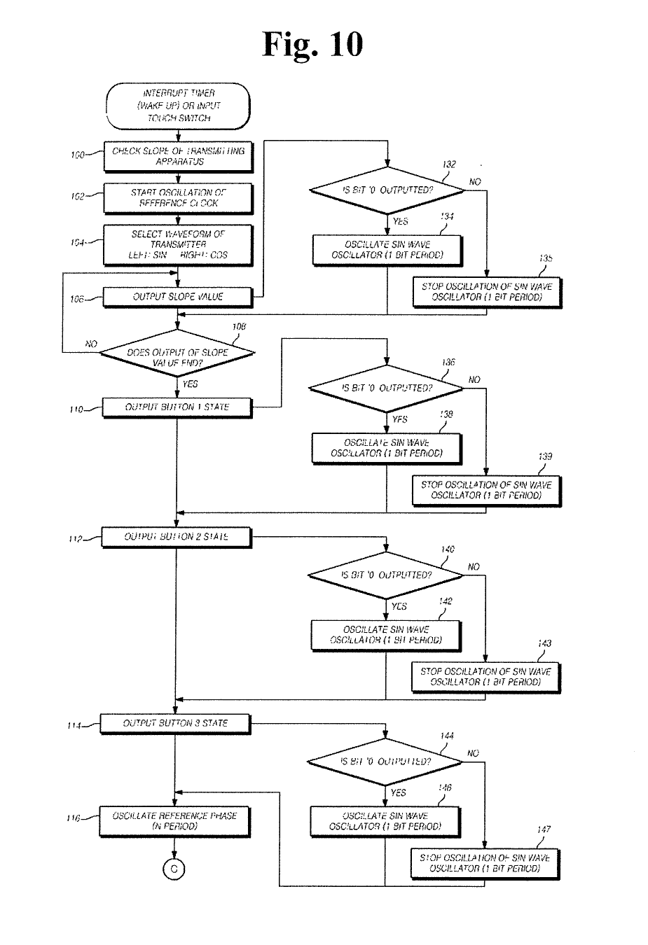

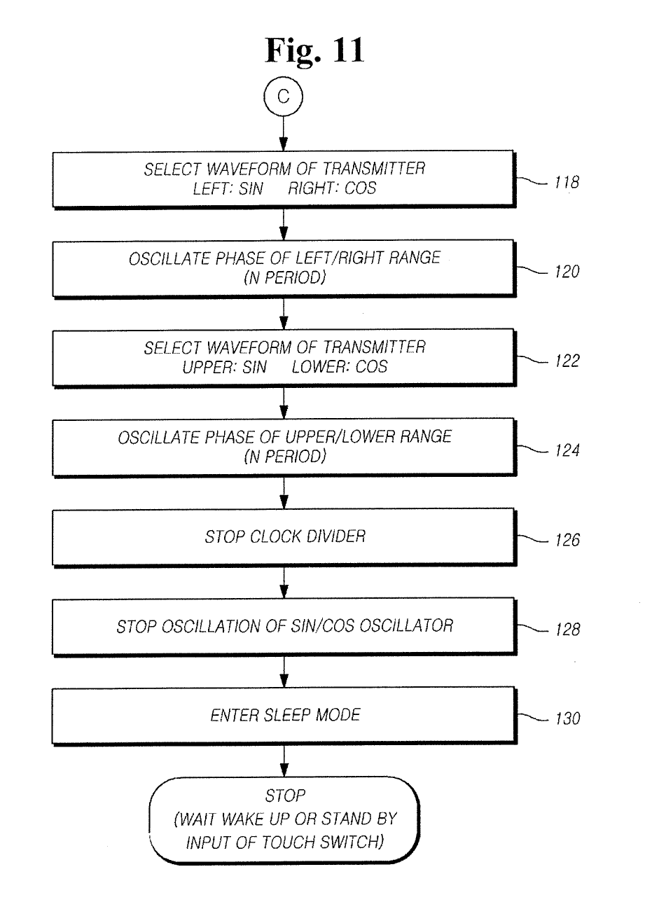

FIGS. 10 and 11 are flowcharts describing an operation in the transmitting apparatus in the position indicating system which can be remotely controlled according to the exemplary embodiment of the present invention.

As shown in FIGS. 10 and 11, when the touch is inputted from the input unit of the touch switch 10 or when the expiration of a set time of the timer 22 is notified to the sleep controlling unit 24, an interrupt signal is inputted into the control unit 20 from the sleep controlling unit and the control unit 20 measures the slope for the gravity axis of the transmitting apparatus by using the slope sensor 14 (step 100) and outputs a control signal to start oscillation of a reference clock (step 102).

Thereafter, the selection terminals S of the selection unit 50 and the distribution unit 60 are activated so that the square wave of a sine-wave phase from the square wave generating unit 40 is outputted from for example, left and right transmitters 82 and 86 by the control signal of the control unit 20 (step 104).

The control unit 20 outputs the square wave by a square wave oscillation controlling signal (step 106) and judges whether bit ‘0’ is outputted (step 132). If bit ‘0’ is outputted, a sine wave oscillator is oscillated during a 1-bit period (step 134). If bit ‘0’ is not outputted, the oscillation of the sine wave oscillator during the 1-bit period stops (step 135).

Thereafter, it is judged whether outputting all bits of the slope value ends (step 108) and in the case where bits to be outputted remain, the output is continued through the output step 106. In the case where the output of the slope value ends, a state output bit of button 1 is set (step 110) and the output state bit is judged, and as a result, the oscillation process of the sine wave oscillator or the sine wave oscillator stopping process is performed. Thereafter, a state output of button 2 is set (step 112) and continuously, the output state bit is judged, and as a result, the oscillation process of the sine wave oscillator or the sine wave oscillator stopping process is performed. Further, a state output of button 3 is set (step 114) and thereafter, the output state bit is judged, and as a result, the oscillation process of the sine wave oscillator or the sine wave oscillator stopping process is performed. The button state output may be designated a multiple number of times.

Thereafter, sin-sin reference phase oscillation is performed with the left and right transmitters during a set N period (step 116) and thereafter, when an input terminal IN1 of the selection unit 50 is activated by the control signal of the control unit 20, a cosine waveform is selected. Therefore, as the waveform of the transmitter, the waveform is selected so that the sine waveform is transmitted from the left side and the cosine waveform is transmitted from the right side (step 118). Further, thereafter, left/right phase oscillation is continued during another predetermined N period (step 120) and as the waveform of the transmitter, the waveform is selected so that the sine waveform is transmitted from the upper side and the cosine waveform is transmitted from the lower side (step 122). In this case, the output terminal OUT1 of the first and second distribution portions 62 and 64 in the distribution unit 60 is selected, such that a transmission waveform is outputted from the upper and lower transmitters.

Thereafter, after the upper/lower phase oscillation is continued during another predetermined N period (step 124), oscillation of the clock divider 30 stops (step 126), and as a result, oscillation of the square wave oscillator 40 including sine and cosine oscillators also stops (step 128).

Thereafter, when the control signal is applied to the sleep controlling unit 24 by the control signal of the control unit 20, the process enters a sleep mode (step 130) and the process stops.

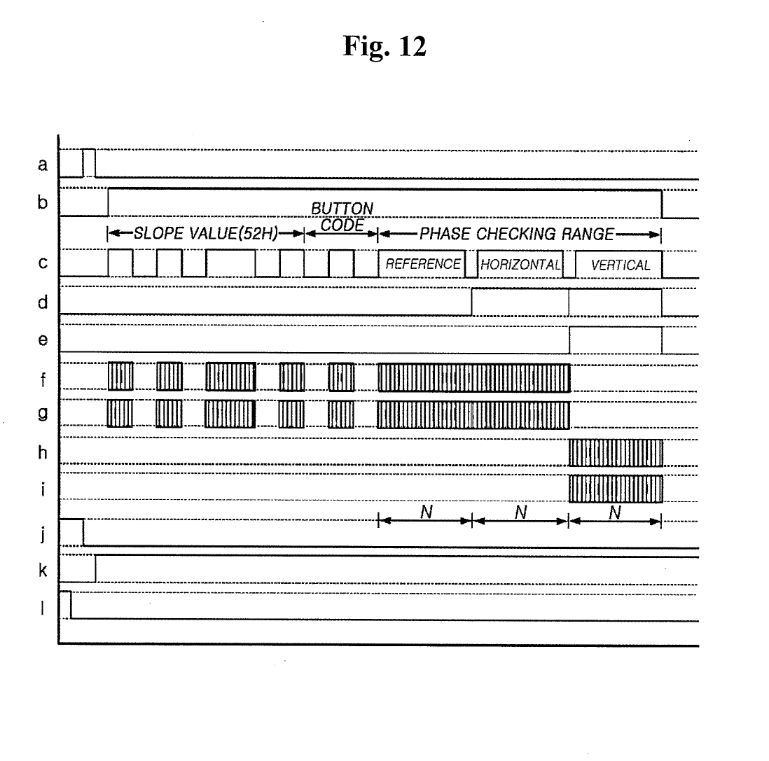

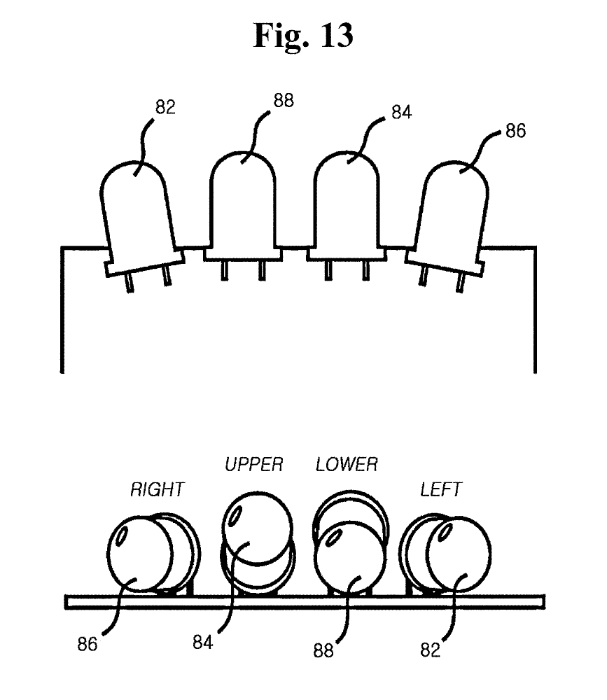

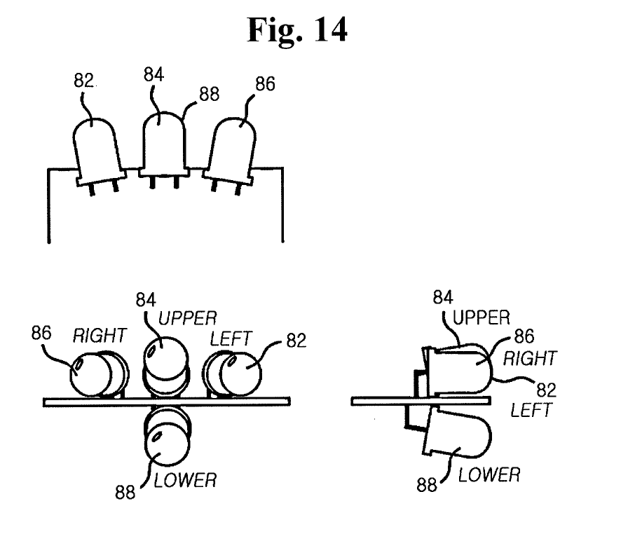

FIG. 12 shows a control timing in the transmitting apparatus of FIG. 9.

As shown in FIG. 12, a represents a wake-up timing signal in the touch switch 10 or the timer 22 and b represents a reference clock controlling signal outputted by the control unit 20 based on a timing signal. c represents a square wave generation controlling signal controlling the square wave generating unit 40 simultaneously with the reference clock controlling signal. The square wave generation controlling signal may be divided into the slope value, a button code, and a phase checking section in terms of an overall transmission section and the phase checking section is divided into a reference phase checking section, a horizontal phase checking section, and a vertical phase checking section. d represents a transmitter waveform selection controlling signal outputted by the control unit 20 and e represents a left-right and upper-lower transmitter selection controlling signal. Further, f and h represent frequency signals outputted from the first and second current amplifying units 72 and 76 and g and i represent frequency signals outputted from the second and fourth current amplifying units 74 and 78. j, k, and l represent control signals outputted from the button switch 12, respectively.

The transmitters 82, 84, 86, and 88 in FIG. 9 are inclined at the same angle from the center as pairs of respective left and right and upper and lower sides to be mechanically installed. Further, various application arrangements such as an arrangement in which four respective transmitters are installed as one component may be achieved.

An infrared light emitting diode may be used as the transmitter in the exemplary embodiment of the present invention and each infrared light emitting diode transmits square waves having different phases and the same frequency, but may be configured to transmit waveforms of a sine wave, a triangular wave, a saw-tooth wave, and other predetermined-shaped waveforms, instead of the square wave.

Waveforms having the same phase for measuring the reference phase are transmitted through the transmitter configured by the infrared light emitting diode and thereafter, waveforms having different phases are transmitted or waveforms having the same phase are transmitted to measure the reference phase, that is, the reference signal and a phase-shifted detection signal are transmitted with a time difference.

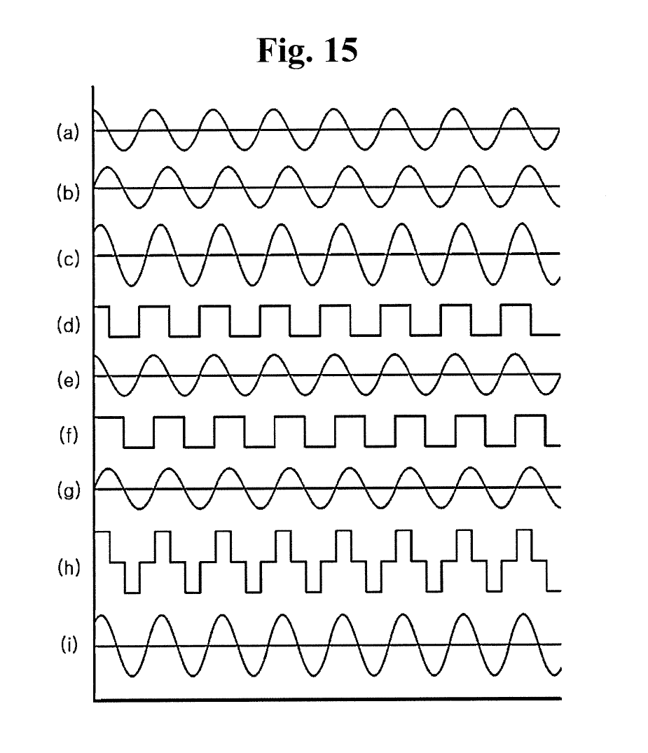

FIG. 15 shows a theoretical sine wave and synthetic wave and waveforms of the synthetic wave, and the square wave which pass through the band filter in the exemplary embodiment of the present invention. The theoretical square wave and the waveform of the sine wave acquired by the square wave which passes through the band filter coincide with each other in terms of the phase. FIG. 15A shows the cosine wave, FIG. 15B shows the sine wave, and FIG. 15C shows the synthetic wave.

FIG. 15D shows the square wave having the cosine (cos) phase actually used in the exemplary embodiment of the present invention, FIG. 15E shows a waveform acquired by processing the waveform of FIG. 15D through the band pass filter in the receiving apparatus to be described below, FIG. 15F represents the square wave having the sine (sin) phase, FIG. 15G shows a waveform acquired by processing the waveform of FIG. 15F through the band pass filter, FIG. 15H shows the synthetic wave of FIGS. 15D and 15E, and FIG. 15I shows a waveform acquired by processing the waveform of FIG. 15H through the band pass filter.

Even in the case where an error of a predetermined phase is generated in filtered waveforms with respect to an input waveform due to processing speed and delay characteristics of an amplification circuit and a band filter circuit, all waveforms are filtered and received with a single circuit in the exemplary embodiment of the present invention, and as a result, a phase difference of the same value is generated and since a phase shift is generated due to the error of the same value in a reference phase signal and a phase signal for position detection, no error is generated in the exemplary embodiment of the present invention using only a relative difference between a reference phase and a complex phase for position detection which are received, as a signal.

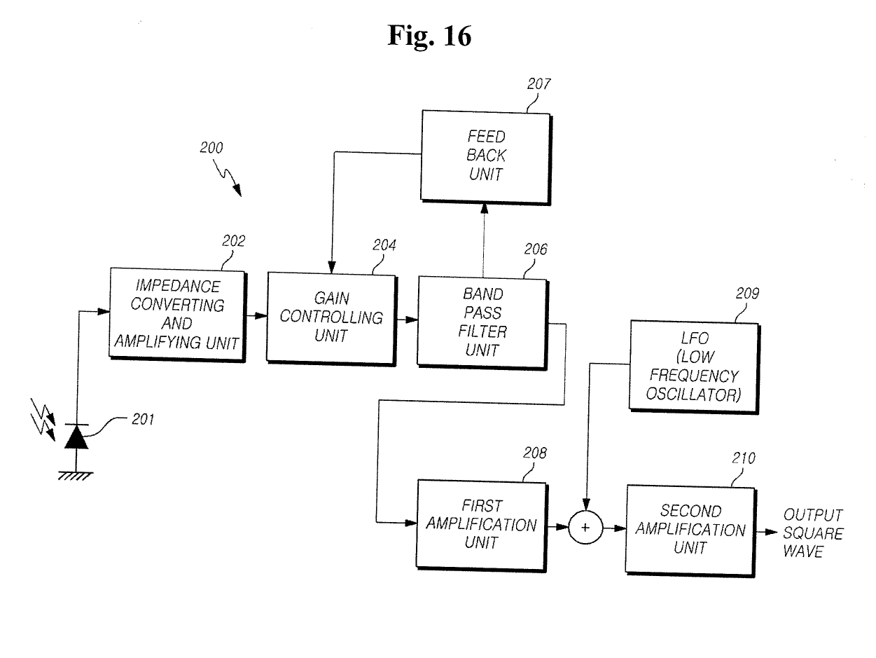

FIG. 16 is a block diagram showing a configuration of a reception amplifying unit 200 of the receiving apparatus to be described below in the position indicating system which can be remotely controlled according to the exemplary embodiment of the present invention.

The receiving apparatus used in the position indicating system according to the exemplary embodiment of the present invention generally includes a reception amplifying unit 200 receiving and amplifying the frequency signal from the transmitting apparatus and a digital signal processing unit 300 performs digital signal processing of the amplified signal of the reception amplifying unit 200.

Further, the reception amplifying unit 200 of the receiving apparatus may include a receiver 201 of which one side is grounded, an impedance converting and amplifying unit 202 connected to the other side of the receiver 201 to reduce a loss at the time of amplifying the signal from the transmitter which is relatively weaker than the intensity of external natural light, a gain controlling unit 204 removing noise from the signal amplified by the impedance converting and amplifying unit 202 and amplifying an AC component, a band pass filter unit 206 outputting only a frequency component of a desired reception signal by filtering an output signal of the gain controlling unit 204, a feed back unit 207 achieving an automatic gain control (AGC) function by outputting a control signal to the gain controlling unit 204 to selectively adjust an amplification level according to an output signal from the band pass filter unit 206, a first amplification unit 208 amplifying the frequency component of the band pass filter unit 206, a low-frequency oscillator (LFO) 209 outputting a low-frequency waveform of a cycle corresponding to the number of measurements N for accumulation with respect to the cycle of the received waveform so as to minutely swing a phase of the received waveform in order to improve resolution of a received coordinate in an accumulation method by multiple samplings, and a second amplification unit 210 receiving a signal mixed with the output signal of the first amplification unit 208 and ultimately amplifying the received signal to output the square wave.

In the exemplary embodiment of the present invention, since only the phase shift is important regardless of the bandwidth of the synthetic wave received in the signal processing, the signal is ultimately amplified through the second amplification unit 210 to be saturated.

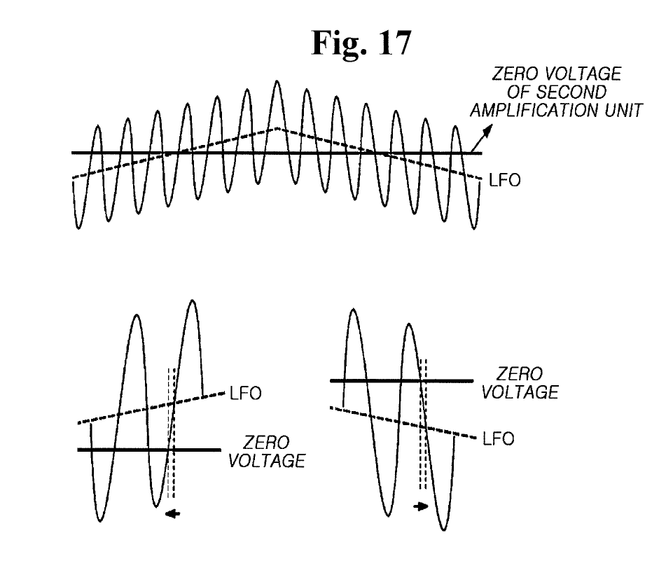

FIG. 17 is a diagram describing a principle of improving resolution of a coordinate by using a method of increasing the number of measurements and accumulating measured values as one feature of the present invention discriminated from the above method.

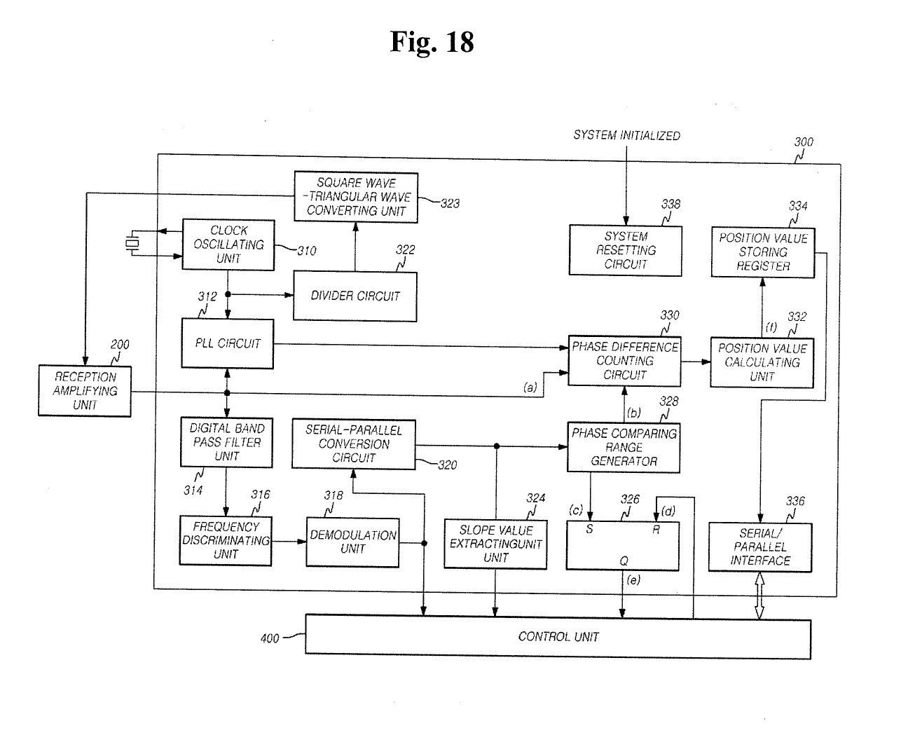

Sampling of a high frequency of multiplying an inputted frequency by a value corresponding to coordinate resolution to be acquired is required to digitally measure the shift of the phase. When the frequency of the reference phase is locked by using a phase locked loop (PLL) circuit in order to measure the phase shift, a value of a phase difference counter 330 of FIG. 18 is initialized to start counting at a shift time (edge point) of the locked reference phase and in this case. Even though the measurement is repeated several times, the measured phase shift has a predetermined value every time, such that even though the measurement values are accumulated in an amount equal to the number of measurement times, errors of the resolution are also accumulated similarly, and as a result, the coordinate resolution is not improved at all.

Since the second amplification unit 210 of FIG. 16 is an ultimate amplifier, the second amplification unit 210 outputs the square wave by outputting 1 when a voltage of the amplified signal is higher than a zero voltage as a comparison voltage of the amplifier and 0 when the corresponding voltage is lower than the zero voltage. The phase of the square wave output is determined at a point (zero cross point) where the input waveform crosses the zero voltage.

Further, as shown in FIG. 17, the sine wave which is the output waveform of the first amplification unit has a substantially linear inclination based on the point where the sine wave crosses the zero voltage of the second amplification unit 210 and when the sine wave is synthesized with the output of the LFO 209, the phase is advanced as much as a voltage difference in a range in which the LFO voltage is positive and the phase is delayed as much as the voltage difference when the LFO voltage is negative as a reference. Therefore, the measurement value of the phase shift including a positive or negative error is measured every time and when the frequency of the LFO is set as a value acquired by dividing an input frequency value by the number of measurement times, that is, when the cycle of the LFO output waveform is set as a value acquired by multiplying the input waveform cycle by the number of measurement times, the sum of errors accumulated in an overall sampling range is 0, and as a result, only the phase shift of the sine wave before the LFO is synthesized is left as the accumulation value.

However, an output bandwidth of the LFO is preferably 1/10 to ⅕ smaller than the bandwidth of the sine wave having a predetermined magnitude, which is outputted from the first amplification unit 208. Further, the waveform of the LFO is preferably the sine wave, the triangular wave, and the saw-tooth wave and although the triangular wave which is comparatively easily generated by integrating the square wave is used in the exemplary embodiment, the waveform is not limited thereto.

FIG. 18 is a block diagram showing a schematic configuration of the digital signal processing unit 300 in the receiving apparatus according to the exemplary embodiment of the present invention.

First, the square wave which has been already amplified in the saturation state is outputted from the reception amplifying unit 200.

Reference numeral 310 represents a clock oscillating unit applying a predetermined frequency clock and reference numeral 312 represents a phase locked loop (PLL) circuit receiving the square wave signal generated from the receiving reception amplifying unit 200 and serving to lock the phase of the received signal so that the phase of the signal inputted at a start point of the phase measurement range is at the same position in order to prevent a malfunction by a boundary value of a counting value at the time of measuring the phase of the received signal.

When the clock oscillating unit 310 generates a predetermined clock and applies the generated clock to a divider circuit 322, a most significant bit of a counter for the divider becomes the square wave output and when the square wave is integrated, the square wave becomes a triangular waveform, and as a result, the square wave output is inputted into a square wave-triangular conversion integrating circuit 232 to be converted into the triangular wave and the output is applied to the reception amplifying unit 200 by using the LFO 209 for converting a phase shift measurement timing.

Reference numeral 314 represents a digital band filter unit filtering the square wave signal outputted from the reception amplifying unit 200 and reference numeral 316 represents a frequency discriminating unit determining whether a carrier frequency is provided by an error limit of the counting value targeted by a cycle measuring method of a carrier signal by using a counter. Reference numeral 318 represents a demodulation unit that demodulates the signal passing through the frequency discriminating unit 316 depending on whether there is a carrier signal or not and inputs the corresponding signal into the control unit 400. An output of the corresponding demodulation unit is connected to the control unit to be used to decode information of the transmitter in the same method as the existing transceiver and further, the output of the corresponding demodulation unit is inputted into a serial-parallel conversion circuit 320 by synchronizing a demodulated serial input signal to convert the serial input signal into parallel data in order to extract the slope value of the transmitting apparatus.

Reference numeral 324 represents a slope value extracting unit extracting the slope value from information received in order to correct the coordinate. The slope value extracted through reference numeral 324 is transferred to the control unit to be used as a rotation angle value required to correct the coordinate depending on a final slope.

Reference numeral 326 represents an R-S flip-flop that receives a signal from a phase comparing range generator 328 to be described below through one input terminal and receives the control signal of the control unit 400 through the other input terminal to output a predetermined output to the control unit 400.

Reference numeral 328 represents the phase comparing range generator generating a range signal for measuring a position signal through a generation signal of the serial-parallel conversion circuit 320, reference numeral 330 represents a phase difference counting circuit generating a resulting signal through the input signal from the reception amplifying unit 200 and the generation signal from the PLL circuit 312, and the signal from the phase comparing range generator 328.

Reference numeral 332 represents a phase value calculating unit calculating a predetermined phase value by processing the signal inputted through the phase difference counting circuit 330 and reference numeral 334 represents a position value storing register storing the signal from the phase value calculating unit 332. Reference numeral 336 represents a serial/parallel interface serial-parallel processing the signal from the position value storing register 334 and inputting the processed signal into the control unit 400. Reference numeral 338 represents a system resetting circuit.

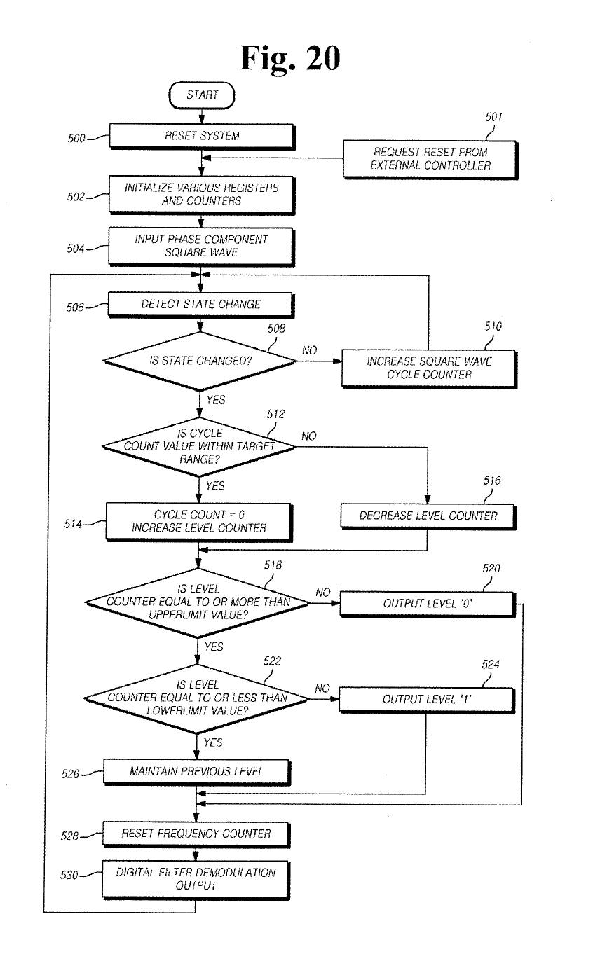

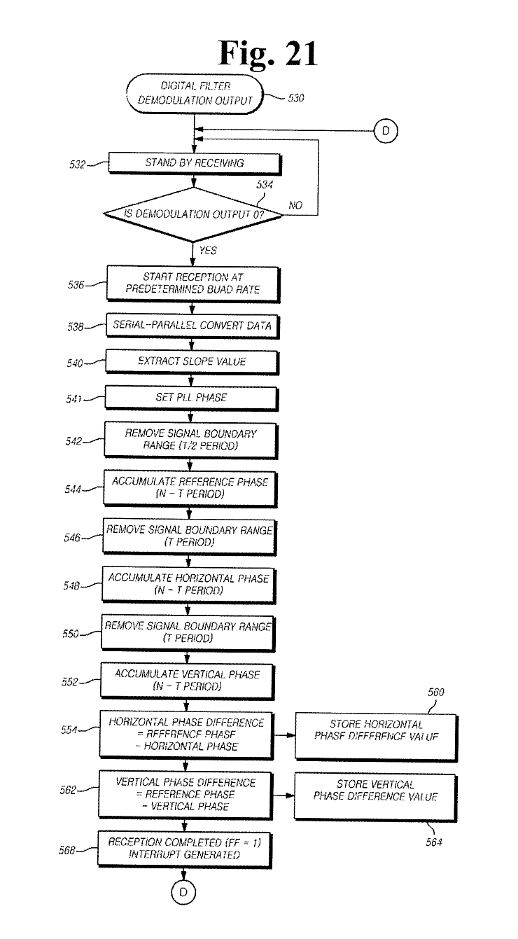

A detailed operation of the receiving apparatus configured as above will be described with reference to FIGS. 20 and 21.

First, when power is inputted, the system is reset to initialize each component of a digital circuit of the receiving apparatus according to the present invention (step 500). As a result, various registers and counters of the digital signal processing unit 300 are initialized (step 502). The initialization process may be performed by a reset request from an external control unit 400 (step 501). Thereafter, when a phase component square wave from the reception amplifying unit 200 is inputted (step 504), the digital band filtering unit 314 detects a state change of a pulse (step 506) (also referred to as an edge detector process). The digital band filter unit 314 judges whether the state is changed thereafter (step 508). When the state is changed, the frequency discriminating unit 316 judges whether a cycle counting value is within a target range (step 512) and when the state is not changed, the cycle of the square wave is continuously counted (step 510) to detect the state change.

When the frequency discriminating unit 316 judges that the cycle counting value is within the target range, a level counter is increased (step 514) and when the cycle counting value is not within the target range, the level counter is decreased (step 516) to judge whether the level counter is equal to or more than an upperlimit value after both processes (step 518). As a result, when it is judged that the level counter is equal to or more than the upperlimit value, level “0” is outputted (step 520) and thereafter, a frequency counter is reset (step 528). If the level counter is not equal to or more than the upperlimit value, it is judged whether the level counter is equal to or less than a lowerlimit value (step 522). As a result, if the level counter is equal to or less than the lowerlimit value, level “1” is outputted (step 524) and thereafter, the frequency counter is reset (step 528) and if the level counter is equal to or less than the lowerlimit value, the previous level is maintained (step 526) and thereafter, the frequency counter is reset (step 528). Thereafter, a digital filter demodulation signal is outputted (step 530).

The process of increasing and decreasing the level counter is the frequency discriminating process through the frequency discriminating unit 316 and the process of outputting level “0” or level “1” corresponds to the demodulation operation by the demodulation unit 318. Since the frequency discriminating and level outputting processes are similar to functions of the existing remote controller, the present invention may be used integrally with the existing remote controller functions with no problem.

As shown in FIG. 21, the digital filter demodulation signal is outputted through the demodulation unit 318 (step 530) and in this case, the receiving apparatus is in a reception stand-by state (step 532). Thereafter, the serial-parallel conversion circuit 320 judges whether the demodulation output is “0” (step 534) and in general, since the demodulation output is a “1” state for no signal, a “0” state indicates that the demodulation output is provided. If the demodulation output is “0”, reception starts at a predetermined buad rate (step 536) and the received data is serial-parallel converted by the serial-parallel conversion circuit 320 (step 538). The slope value transmitted from the transmitting apparatus is extracted from the serial-parallel converted data (step 540).

Thereafter, the digital signal processing unit sets the phase of the PLL circuit 312 (step 541), removes a signal boundary range t/2 through the phase comparing range generator 328 (step 542), and thereafter, calculates a reference phase period (N-t) to accumulate the calculated reference phase period (step 544). Further, thereafter, the digital signal processing unit removes another signal boundary range t (step 546) and thereafter, calculates a ‘horizontal’ phase period (N-t) to accumulate the calculated ‘horizontal’ phase period (step 548). In addition, thereafter, the digital signal processing unit removes another signal boundary range t (step 550) and thereafter, calculates a ‘vertical’ phase period (N-t) to accumulate the ‘vertical’ phase period (step 522). The signal boundary range is removed to minimize a calculation error by removing a range including a shift process of the phase.

Thereafter, a horizontal phase difference is calculated with a value acquired by subtracting the horizontal phase from the reference phase (step 554) and the value is stored in a register as a horizontal phase difference value (step 560). Further, a vertical phase difference is calculated with a value acquired by subtracting the vertical phase from the reference phase (step 562) and the value is stored in the register as a vertical phase difference value (step 564). Thereafter, the phase comparing range generator 328 outputs a reception completion interrupt signal (step 568) and in this process, the phase comparing range generator 328 generates a set signal in the flip-flop 326. Thereafter, the reception stand-by state is continued.

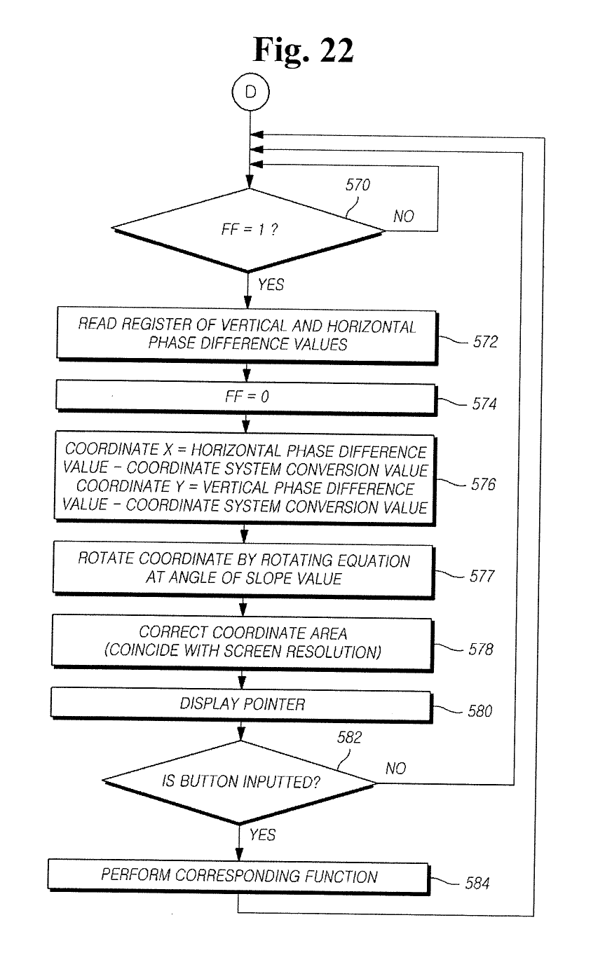

FIG. 22 is a flowchart showing an operation in the control unit after the reception interrupt is generated in the flowchart of FIG. 21. As shown in FIG. 22, the external control unit 400 connected with the receiving apparatus checks a state of the flip-flop at all times and judges whether the flip-flop 326 is set, i.e., ‘1’ (step 570) and if the flip-flop 326 is ‘1’, the control unit 400 reads data from the position value storing register 334 (step 572). Thereafter, the control unit 400 resets the flip-flop 326 (FF=0) (step 572).

The control unit 400 converts a coordinate system by using position x read from the register 334 as the horizontal phase value and converts the coordinate system by using position y as the vertical phase value (step 576). The control unit 400 calculates the slope value acquired through the slope value extracting unit 324 by using the rotating equation shown in FIG. 8 to determine new X and Y coordinates. Thereafter, a coordinate area is corrected to coincide with screen resolution (step 578) and displayed (step 580).

Thereafter, it is judged whether there is a button switch input of the transmitting apparatus (step 582) and when there is the button input, a corresponding function is performed (step 584) and when there is no button input, the set state of the flip-flop is judged again.

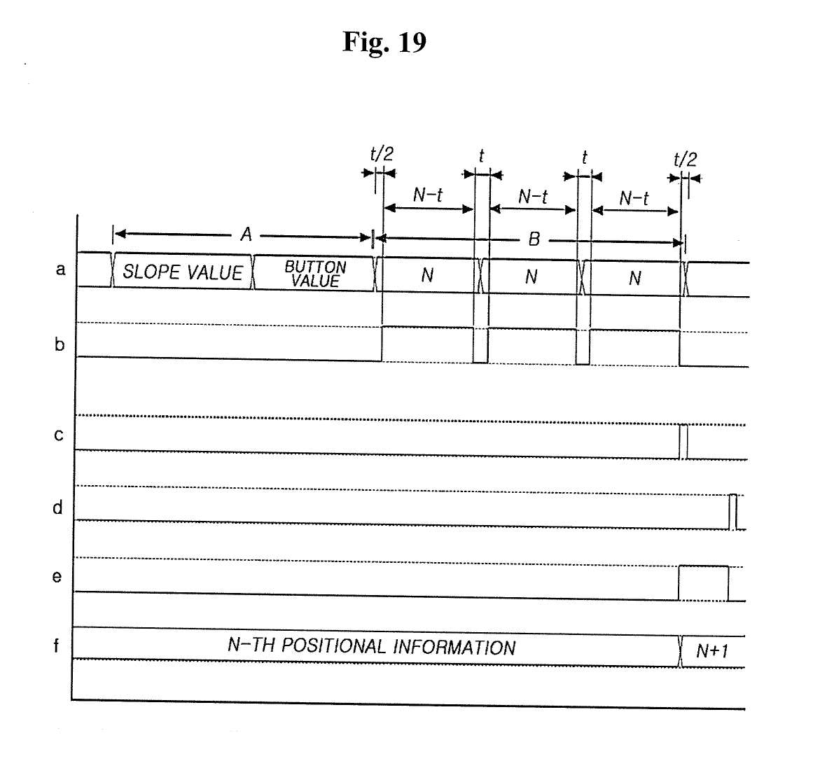

A timing diagram of each of information extraction and phase measurement in the demodulated received signal is shown in FIG. 19. In FIG. 19A, A represents a signal range including the slope value and the button switch value of the transmitting apparatus and B represents a range to measure the shift of the phase. A signal in the signal range represents the signal generated from the reception amplifying unit 200 of FIGS. 16 and 17. As shown in the figure, the slope value range A of the transmitting apparatus is divided into two ranges of a slope value range and a button code range and the range B to measure the shift of the phase is divided into three ranges of a reference phase signal range for measuring the preference phase, a horizontal position phase signal range for measuring positional information of a horizontal axis, and a vertical position phase signal range for measuring positional information on a vertical axis, as the respective ranges having a magnitude of N. Boundary surfaces of the respective ranges represent the signal boundary ranges t/2 and t.

FIG. 19B shows a waveform signal depending on each signal range outputted from the phase comparing range generator 328 on the basis of the signal inputted from the serial-parallel conversion circuit 320. FIG. 19C shows a set signal applied to the R-S flip-flop 326 at the time when a phase shift measurement range B inputted from the phase comparing range generator 328 ends.

FIG. 19D represents the reset signal applied to the R-S flip-flop 326 from the control unit 400 and FIG. 19E shows the signal outputted from the R-S flip-flop 326 of FIG. 18 and outputted to the control unit 400. FIG. 19F shows the output signal from the phase value calculating unit 332 of FIG. 18, which is a data signal regarding the positional information inputted into the position value storing register 334.

As shown above, the internal flip-flop is set at the time when the phase measurement ends (FIG. 19C), the output is transferred to an external system, such that a fact that new positional information is measured and updated is notified to each control circuit (FIG. 19E), and further, the measured value is stored in the position value storing register 334 (FIG. 19F) to prevent data from being lost by further measurement of the received value.

The control unit 400 reads data in the position value storing register 334 and resets the internal flip-flop 326 at the time when it is verified that the measurement of the new positional information is completed to verify a measurement completion time of new data again. The measured value is transferred to the control unit 400 by the serial/parallel interface 336 and displayed on the screen 2 through correction of the slope value and conversion of the coordinate system such as conversion of a screen coordinate system.

The control unit 400 may be configured by an external microcomputer circuit or an external system connected directly to a personal computer.

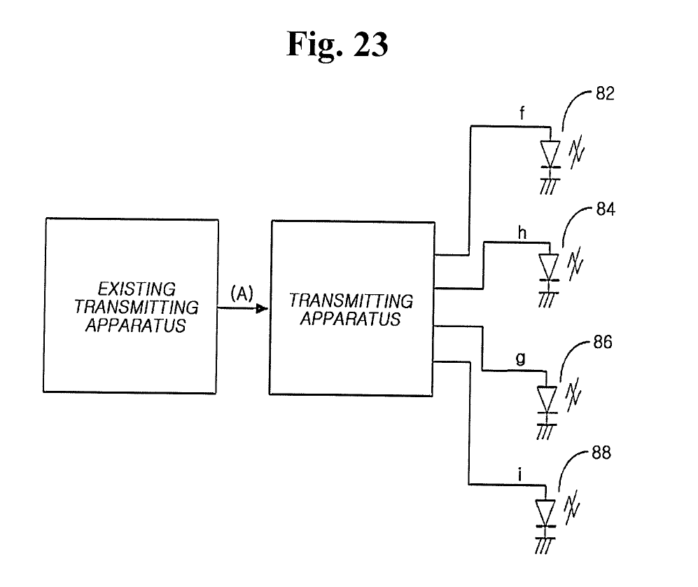

FIG. 23 is an additional exemplary embodiment for acquiring an effect of the present invention while maintaining 100% compatibility to a signal flow of an existing system in a method of adding the transmitting apparatus to an existing transmitter so as to more easily implement the exemplary embodiment of the present invention.

The position indication transmitting apparatus according to the exemplary embodiment of the present invention as a kind of module or chip mounted on a general transmitting apparatus in the related art to indicate a position according to a concept of the present invention and includes a slope sensor measuring the slope of the transmitting apparatus with respect to the gravity axis, two or more (preferably, four) transmitters transmitting waveforms for transmitting positional information signals having different phases and the same frequency to the receiving apparatus so as to acquire positional information from the shift of the phase which is received by the receiving apparatus and shifted from a reference signal, and a control unit receiving an output signal of the existing transmitting apparatus and transmitting the output signal including the slope value from the slope sensor and the positional information.

When the output signal of the transmitter of the existing general transmitting apparatus is inputted into the transmitting apparatus in order to start the operation of the position indication transmitting apparatus according to the exemplary embodiment of the present invention, the positional information and slope value information which the transmitting apparatus of the present invention should transmit is added to the output of the transmitter of the existing transmitting apparatus which is inputted to be instead transmitted through the transmitters of the position indication transmitting apparatus by the exemplary embodiment.

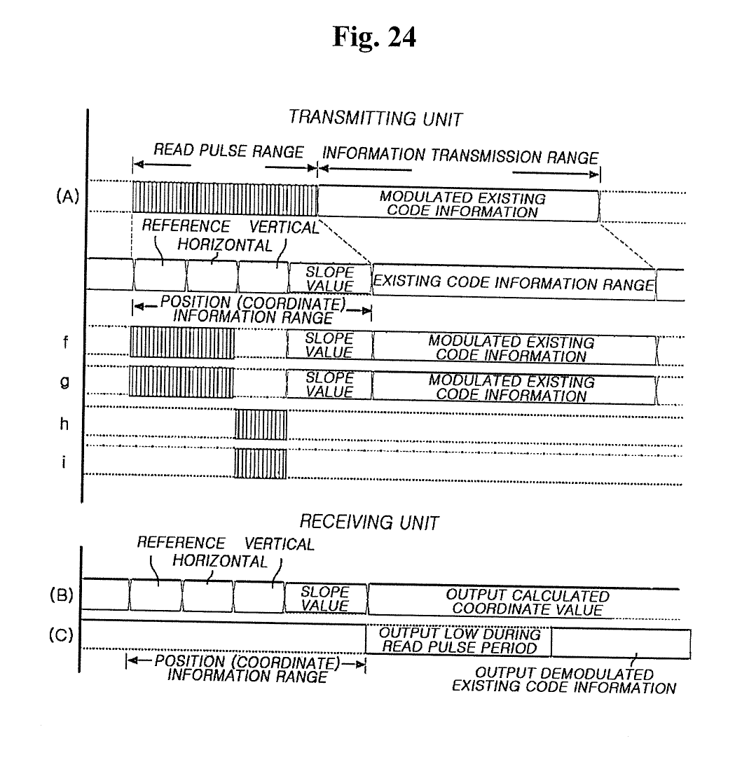

In this case, FIG. 24 shows the signal flow at each point of FIG. 23 and demodulation signal processing of a receiving unit (the receiving apparatus of the present invention and the existing receiving apparatus).

As shown in FIG. 24, most of existing transmitting apparatuses have a read pulse range of several msecs in order to start signal transmission (FIG. 24) and since the corresponding read pulse range of the existing transmitting apparatus is continuation of the carrier frequency, the read pulse range is different from the positional information range of the present invention in terms of only the phase and both ranges have similar shapes.

Accordingly, instead of the read pulse range transmitted by the existing transmitting apparatus, positional information such as reference, vertical, and horizontal position information of the present invention is inserted and transmitted and thereafter, the slope value is added and transmitted as information and the waveform of the existing transmitter which is stored in advance is added and transmitted.

In the receiving unit, corresponding information is acquired and used by the above-mentioned method with respect to information which the transmitting apparatus of the present invention adds in the receiving apparatus of the present invention and an original signal is restored like the waveform outputted by the transmitter of the existing transmitting apparatus to be transmitted to the existing receiving apparatus, thereby implementing a position indication function required in the present invention without changing functions of the existing transmitting and receiving system.

In the exemplary embodiment of the present invention, when phase comparison is completed by only a one-time measurement, an accumulation method in which the phase is measured several times and an average value thereof is acquired to reduce an error and is used in order to solve a problem that uncertainty by measurement precision is increased due to noise.

As described above, since the horizontal signal and the vertical signal which are transmitted are received by using the single infrared receiver simultaneously in the exemplary embodiment of the present invention, the square waves having sine and cosine phases are received in different bandwidths according to the orientation angle of the present invention due to the orientation characteristic of the transmitter, respectively, and the sum of the square waves having the determined bandwidths is received in this circuit to acquire the square wave having the same phase with respect to the waveform shown in FIG. 15H through the amplification, band pass filter, and saturation, and the square wave is digitally processed through a module circuit configured at the terminal to calculate a shift amount from the reference phase, thereby providing the positional information to the system.

Since the present invention provides a completely new type of position indicating system which can be remotely controlled in which the position indicating system has a comparatively simple circuit configuration and does not require an additional optical device, effective performance is achieved and an S/N ratio is improved to miniaturize the circuit and reduce a manufacturing cost and the positional information is wirelessly transmitted/received by just lifting and orientating the transmitter to the target position, that is, it is very easy to use the position indicating system and the position indicating system can be compatible to the existing remote controller using the carrier frequency in terms of a communication method to substitute for the existing remote controller without the position indicating function or to be integrated with the function of the existing remote controller without changing the circuit.

The present invention provides a position indicating system, which is very easy to use and determines a position of a plane by a movement of a cursor according to a direction indicated by a transmitter, like a movement along a trajectory of rays of a flashlight.

As a transmission method, an absolute coordinate displaying method may be used, in which all positions can be designated through one-time transmission with respect to the overall position of the plane during designating the position or a method of displaying a relative coordinate system may be used to determine a subsequent position by adding and subtracting a newly received phase shift based on a previous position.

There is provided a signal processing apparatus using a demodulation method in which the frequency or cycle of the signal is measured through not an existing analog detection of the existing transmission signal but a digital signal processing using the frequency counter dividing the reference clock to perform detection and demodulation of the signal, thereby maintaining compatibility to the existing remote controller.

Although the transmitting and receiving apparatuses are configured by a the infrared transmitter and the infrared receiver, in the exemplary embodiment of the present invention, the transmitting and receiving apparatuses are not limited thereto and may be configured by an ultrasonic transmitter and an ultrasonic receiver or an RF transmitter and an RF receiver.

Further, a precise amplifier requiring linearity needs not be used, correction of a circuit depending on a temperature change is not required, and an influence is small even with respect to noise. An accumulation operation which is impossible in the related art is enabled by adjusting a sampling point of time by synthesizing a low-frequency signal having a cycle corresponding to N times (the number of measurement times) of the carrier cycle to ultimately increase position indicating resolution, integrate the circuit, a low cost and high functioning are implemented as a structure that does not require design of a complicated and particular amplification circuit or mechanism which is not general for precision, further integration with the existing remote indicator, that is, the remote controller is enabled by maintaining signal processing with and mechanical compatibility to the remote controller to delete common mechanism and circuit parts, and discrimination of an external environment or noise is apparent to reduce influence on performance even under bad conditions, thereby implementing excellent performance in designating the position.

According to the present invention, it is easy to move a cursor in using electronic apparatuses, e.g., a TV, a computer, a VCR, an LDP, a DVD player, a VOD system, a cable TV terminal, various communication terminals, a home game machine, a computer for children, and the like.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A transmitting apparatus for remotely indicating a position of a plane provided in a receiving apparatus, comprising:
a button switch input unit including a button switch;
a slope sensor measuring a slope of the transmitting apparatus with respect to a gravity axis; and
two or more transmitters transmitting waveforms for transmitting positional information signals having different phases and the same frequency to the receiving apparatus so as to acquire positional information from the shift of the phase which is received by the receiving apparatus and shifted from a reference signal,
wherein slope value information measured by the slope sensor is included in the waveform.

2. The apparatus as defined in claim 1, further comprising a touch-type touch switch for displaying a start and an end of transmission of the waveforms for transmitting positional information signals.

3. The apparatus as defined in claim 2, further comprising:
a control unit generating a control signal according to an operation of the touch switch;
a clock divider generating a clock of a predetermined frequency according to the control signal of the control unit;
a square wave generating unit generating a square wave of sine and cosine waveforms according to the clock generated by the clock divider;
a selection unit receiving the square wave of the sine and cosine waveforms of the square wave generating unit and outputting a selection signal by the control signal of the control unit;
a distribution unit receiving one square wave of the square wave generating unit and applying a predetermined output signal according to the control signal of the control unit; and
a current amplifying unit amplifying a distribution signal applied by the distribution unit,
wherein the two or more transmitters transmit a predetermined signal based on the amplification signal from the current amplifying unit.

4. The apparatus as defined in claim 3, wherein the control unit outputs a reference clock controlling signal, a square wave oscillation controlling signal, a right and lower transmitter waveform selection controlling signal, and a selection signal of left, right, upper, and lower transmitters and generates a control signal for controlling a sleep controller generating a control signal according to a timing signal of a timer counting a predetermined time.

5. The apparatus as defined in claim 3, wherein the square wave generating unit includes a sine and cosine phase generating unit having an enable terminal (EN) which is connected with an input terminal (IN) connected to an output terminal of the clock divider to be enabled by the control signal of the control unit.

6. A receiving apparatus for remotely indicating a position which receives waveforms for transmitting positional information from a transmitting apparatus to indicate a position on a plane,
wherein the receiving apparatus receives waveforms for transmitting positional information signals having different phases and the same frequency from the transmitting apparatus and acquires positional information from a shift of a phase shifted from a reference signal and then displays the position on the plane, and
wherein the receiving apparatus extracts a slope value of the transmitting apparatus with respect to a gravity axis included in the waveforms for transmitting the positional information signals and thereafter, and corrects a coordinate of the positional information depending on a slope.

7. The apparatus as defined in claim 6, further comprising a low-frequency oscillator (LFO) outputting a low-frequency waveform of a cycle corresponding to the number of measurements N for accumulation with respect to the cycle of the received waveform so as to minutely swing a phase of the received waveform in order to improve resolution of a received coordinate in an accumulation method by multiple samplings.

8. The apparatus as defined in claim 7, further comprising:
a reception amplifying unit receiving and amplifying the frequency signal from the transmitting apparatus and a digital signal processing unit performs digital signal processing of the amplified signal of the reception amplifying unit,
wherein the reception amplifying unit includes:
a receiver of which the one side is grounded,
an impedance converting and amplifying unit connected to the other side of the receiver to reduce a loss at the time of amplifying the signal from the transmitter which is relatively weaker than the intensity of external natural light,
a gain controlling unit removing noise from the signal amplified by the impedance converting and amplifying unit and amplifying an AC component,
a band pass filter unit outputting only a frequency component of a desired reception signal by filtering an output signal of the gain controlling unit,
a feed back unit achieving an automatic gain control (AGC) function by outputting a control signal to the gain controlling unit to selectively adjust an amplification level according to an output signal from the band pass filter unit,
a first amplification unit amplifying the frequency component of the band pass filter unit,
a low-frequency oscillator (LFO) outputting a low-frequency waveform of a cycle corresponding to the number of measurements N for accumulation with respect to the cycle of the received waveform so as to minutely swing a phase of the received waveform in order to improve resolution of a received coordinate in an accumulation method by multiple samplings, and
a second amplification unit receiving a signal mixed with the output signal of the first amplification unit and ultimately amplifying the received signal to output the square wave.

9. The apparatus as defined in claim 7, wherein the digital signal processing unit includes:
a clock oscillating unit applying a predetermined frequency clock,
a phase locked loop (PLL) circuit receiving the square wave signal generated from the receiving reception amplifying unit and serving to lock the phase of the received signal so that the phase of the signal inputted at a start point of the phase measurement range is at the same position in order to prevent a malfunction by a boundary value of a counting value at the time of measuring the phase of the received signal,
a divider circuit performing dividing in synchronization with the predetermined clock generated from the clock oscillating unit,
a serial-parallel conversion circuit serial-parallel converting an output signal from the divider circuit,
a digital band filter unit filtering the square wave signal outputted from the reception amplifying unit,
a frequency discriminating unit determining whether a carrier frequency is provided by an error limit of the counting value targeted by a cycle measuring method of a carrier signal by using a counter,
a demodulation unit demodulating the signal passing through the frequency discriminating unit 316 depending on the carrier signal or not,
a serial-parallel conversion circuit converting a serial input signal among signals demodulated from the demodulation unit into parallel data in synchronization with a reference clock according to the signal applied form the divider circuit,
a slope extracting unit extracting a slope of the transmitting apparatus from the signal demodulated by the demodulation unit,
an R-S flipflop that receives a signal from a phase comparing range generator through one input terminal and receives the control signal of the control unit through the other input terminal to output a predetermined output to the control unit,
the phase comparing range generator generating a range signal for measuring a position signal through a generation signal of the serial-parallel conversion circuit and generating the predetermined signal at one terminal of the R-S flip-flop,
a phase difference counting circuit generating a resulting signal through the input signal from the reception amplifying unit 200 and the generation signal from the PLL circuit, and the signal from the phase comparing range generator,
a phase value calculating unit calculating a predetermined phase value by processing the signal inputted through the phase difference counting circuit,
a position value storing register storing the signal from the phase value calculating unit,
a serial/parallel interface serial-parallel processing the signal from the position value storing register and inputting the processed signal into the control unit, and
a system resetting circuit maintaining a reset state by a system reset controlling signal.

10. A position indication transmitting apparatus mounted on a general transmitting apparatus to remotely indicate a position on a plane provided in a receiving apparatus, comprising:
a slope sensor measuring a slope of the transmitting apparatus with respect to a gravity axis;
two or more (preferably, four) transmitters transmitting waveforms for transmitting positional information signals having different phases and the same frequency to the receiving apparatus so as to acquire positional information from the shift of the phase which is received by the receiving apparatus and shifted from a reference signal; and
a control unit receiving an output signal of the existing transmitting apparatus and transmitting the output signal including the slope value from the slope sensor and the positional information.

11. The apparatus as defined in claim 10, wherein the control unit controls the slope value and positional information included in a read pulse range of an output signal of the general transmitting apparatus to be transmitted.
